(19) United States
(12) Patent Application Publication
(10) Pub. No.: US 2017/0148035 A1
(43) Pub. Date: May 25, 2017

(54) Buying Stage Determination in a Digital Medium Environment

(71) Applicant: Adobe Systems Incorporated, San Jose, CA (US)

(72) Inventors: Meghanath Macha Yadagiri, Hyderabad (IN); Ritesh Noothigattu, Visakhapatnam (IN); Shivam Garg, Ambala Cantt (IN); Abhishek Kandoi, New Delhi (IN); Atanu R. Sinha, Boulder, CO (US)

(21) Appl. No.: 14/949,088

(22) Filed: Nov. 23, 2015

(51) Int. Cl. G06Q 30/02

(52) U.S. Cl. CPC G06Q 30/0201

(57) ABSTRACT

Buying stage determination techniques in a digital medium environment are described to model and control user interaction with a service provider to purchase a good or service through identification of stages in a buying cycle associated with users. Usage data is obtained that at least describes interactions by one or more users with the service provider that occurred during previous sessions. The marketing interactions in the obtained usage data are classified and quantified for respective said users using one or more features. Generation of a model of the stages of the buying cycle is controlled using the quantified usage data. The model is configured to identify a stage in the buying cycle that is associated with a respective said user, which is usable to control further marketing interactions supported for that user.

### BACKGROUND

Marketers may target potential customers in a variety of ways in an attempt to convert these potential customers to actual customers. For example, marketers can engage in an email campaign, configure a website, and so on in a digital medium environment to promote marketing interactions (e.g., clicks on a link, views of an images in an email, and so forth) that inform and encourage the user to purchase a good or service.

Potential customers typically go through a buying cycle in which the desires of the potential customers change based on corresponding stages at which the potential customers are located in the buying cycle. Consider a simplified example in which a customer enters a clothing store and does not have a purchase of any particular good or service in mind. Accordingly, the customer may not desire much in the way of attention and feel that a salesperson would hinder a peaceful browsing experience in the store.

On the other hand, another customer may also enter the same store. However, in this situation, this other customer has an urgent need to purchase a particular product (e.g., a pair of shoes) and therefore desires immediate help from a salesperson. If this other customer is not able to get this attention, the customer may become frustrated and leave the store. The difference between the two stated examples is a stage in a buying cycle in which the customers are located. Thus, a customer's expectations regarding a desired amount of interaction change depending on where the customer is located in the buying cycle.

Expanding this example in a digital medium environment, a potential customer desiring a higher engagement level needs to be targeted/personalized differently from a potential customer who is not yet reached this level in order to effectively convert these potential customers into actual customers. Therefore, an understanding of the stage at which the customer is located in the buying cycle has a high degree of importance to marketers, customers, and providers of goods and services. However, these stages are hidden and not directly observable using conventional techniques. As such, conventional marketing techniques in digital medium environments are not able to consider stages in a buying cycle and thus are inefficient and may have limited effectiveness in converting potential customers to actual customers. Accordingly, conventional techniques may be frustrating to potential customers, inefficient for providers of the goods and services, and inaccurate for marketers that rely on these conventional techniques in order to target potential customers.

### SUMMARY

Buying stage determination techniques in a digital medium environment are described. In one or more implementations, the digital medium environment is configured to model user interaction with a service provider to purchase a good or service through identification of stages in a buying cycle associated with users. This modeled user interaction is usable to control marketing interactions with the users, such as subsequent interaction with the users based on previous interactions. To start, usage data is obtained that at least describes interactions by one or more users with the service provider that occurred during current and/or previous sessions with the service provider, e.g., with webpages of a website, emails, “click-throughs” on advertisements, and so forth.

The marketing interactions in the obtained usage data are classified and quantified for respective users using one or more features, e.g., number of times the interactions occurred, an amount of time involving each interaction, and so forth. This data is used to infer hidden stages of a buying cycle as part of generation of a model of the stages of the buying cycle using the quantified usage data, e.g., through use of hidden Markov model techniques. The model is configured to identify a stage in the buying cycle that is associated with a respective user, which is usable to control further marketing interactions supported for that user, e.g., which webpages to provide, emails to send, and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ buying stage determination techniques described herein.

FIG. 2 depicts a system in an example implementation in which a stage determination module of FIG. 1 is shown in greater detail.

FIG. 3 depicts a system in an example implementation showing operation of a stage control module of a stage determination module of FIG. 2 in greater detail.

FIG. 4 depicts a graph showing a relationship between hidden states that correspond to stages in a buying cycle and observables that are usable to determine these hidden states.

FIGS. 5 and 6 include example implementations having graphs that illustrate goodness of the techniques described herein through evaluation of customer-level predictability.

FIG. 7 is a flow diagram depicting a procedure in an example implementation of a digital medium environment to model and control user interaction with a service provider to purchase a good or service through identification of stages in a buying cycle associated with users.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

As part of interaction in a digital medium environment with a service provider (e.g., a website) that provides a good or service, a potential customer typically progresses through different stages in a buying cycle to purchase the good or service. Each of these stages has different corresponding expectations of the potential customer that are to be met by the service provider as part of converting this potential customer into an actual customer.

For example, an “awareness stage” in the buying cycle refers to awareness by the potential customer of various offerings of the service provider, e.g., goods or services made available for purchase via a website. Thus, a potential customer in this stage typically desires and expects limited engagement, e.g., a fewer number of emails, advertisements, and so forth, as the potential customer's interest at this point lacks focus.

Once a potential customer becomes aware, the customer shifts into an “interest stage” in the buying cycle which describes the customer's interest in particular goods or services being offered from the service provider. Due to this particular interest, the potential customer typically then wants increased engagement on the part of the service provider in relation to these particular goods or services.

While browsing, the potential customer may then desire to purchase a particular good or service from the service provider and accordingly perform a focused study of the particular good or service, which is defined as a “desire stage” in the buying cycle. The potential customer, for instance, may select links in an email, navigate to particular webpages, and so on to learn more about the particular good or service and thus desires an even further increase in a level of engagement by the service provider.

From this, the potential customer may enter a purchase phase referred to as a “conversion stage” in the buying cycle in which the customer purchases the good or service desired from the service provider, e.g., from a website from which the customer became aware of and interested in the good or service. Thus, at this point the potential customer is converted to an actual customer of the service provider.

In the example above there are four different stages defined for a buying cycle for a good or service from the provider. At each of these stages, the customer expects different behaviors in relation to the website, emails, advertisements, and so forth that are collectively referred to as “marketing interactions” in the following. For example, as the customer progresses through the stages from awareness, to interest, to desire, and to conversion an amount of engagement desired as part of marketing interaction with the customer from the service provider (e.g., the website) generally increases. A type of marketing engagement desired by the customer at each of these stages may also change, such as a desire to view emails and then advertisements having different amounts of information about a product or service, different levels of offers (e.g., different discount levels may have different levels of interest based on the stage), and so forth. Thus, awareness of the stage at which a potential customer is positioned in a buying cycle may increase efficiency of converting that customer through targeted marketing interactions based on this awareness.

Buying stage determination techniques in a digital medium environment are described. A model is generated that is usable to infer stages in a buying cycle as hidden states based on observables, such as a number of times viewing a particular webpage, an amount of time viewing a particular webpage, past or current purchases, and so on. These observables may leverage past marketing interactions of a user with a service provider (e.g., past browser sessions that involve interaction with particular webpages of a website) and may also include a current session. In this way, the techniques described herein may capture progression of a user through the stages of the buying cycle that occurs over multiple sessions, which is not possible using conventional techniques.

Additionally, the techniques described herein may leverage an affinity of a customer in relation to a service provider. In this way, the techniques may incorporate an awareness that a customer who has already made a purchase from the service provider has an increased likelihood of passing through the stages of the buying cycle more quickly than a user that has not already made a purchase. Conventional techniques do not capture such an affinity as part of stage identification and thus are unable to address this quick progression, which may result in inaccurate determinations and thus inaccuracies in a response to these determinations, e.g., a wrong level and type of engagement of the service provider with the customer.

Further, the techniques described herein are configurable to assign different weights to different classifications of marketing interactions, e.g., with particular webpages. For example, a customer that views a product details webpage multiple times is likely to have increased interest in regard to a product or service than a customer that views a homepage of the website multiple times. Thus, in a digital medium environment a classification of marketing interactions provides vital understanding of an intent of a user in relation to the interactions and thus insight regarding to which stage in the buying cycle the user has likely progressed. This is not performable using conventional techniques and as such these conventional techniques are incapable of understanding differences in a user's interest, thus leading inaccuracies in the determination and actions taken as a result of the determination.

Yet further, the techniques described herein are configurable to incorporate changes in temporal behavior of a user across multiple browsing sessions, e.g., through use of a non-homogeneous hidden Markov model as further described below. For example, a weight may be given to marketing interactions that decays based on an amount of time that has passed since the marketing interactions occurred, e.g., since a user viewed an email, webpage, and so forth. This is performable over multiple sessions with the service provider as described above and thus may also address a user's progression through different stages of a buying cycle over different sessions.

In the following discussion, an example environment is first described that employs the buying stage determination techniques described herein. Example procedures are then described which are performable in the example environment as well as other environments. Consequently, performance of the example procedures is not limited to the example environment and the example environment is not limited to performance of the example procedures.

Example Environment

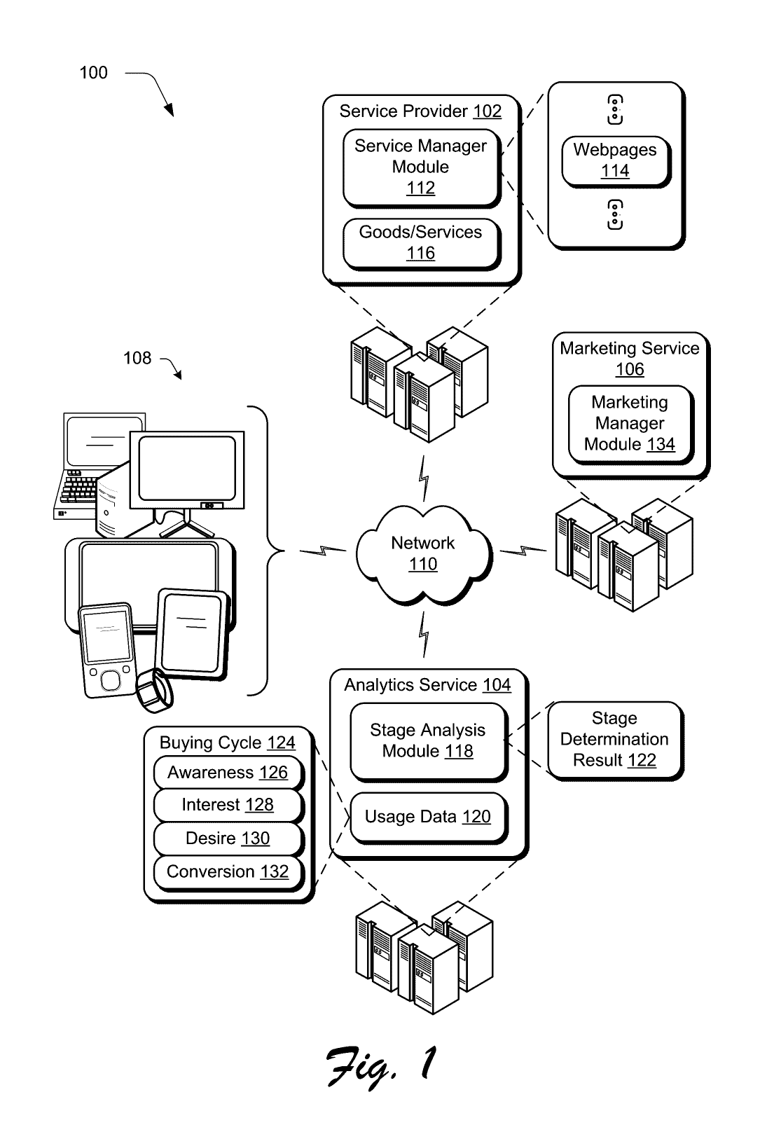

FIG. 1 is an illustration of an environment 100 in an example implementation that is operable to employ buying stage determination techniques described herein. The illustrated environment 100 includes a service provider 102, an analytics service 104, a marketing service 106, and a plurality of devices 108 configured to consume digital marketing campaigns, each of which is communicatively coupled to a network 110.

Devices that implement the service provider 102, the analytics service 104, the marketing service 106, and the plurality of devices 108 may be configured in a variety of ways. A device 108, for instance, may be configured as a desktop computer, a laptop computer, a mobile device (e.g., assuming a handheld configuration such as a tablet or mobile phone), and so forth as illustrated. Thus, the devices 108 may range from full resource devices with substantial memory and processor resources (e.g., personal computers, game consoles) to a low-resource device with limited memory and/or processing resources (e.g., mobile devices).

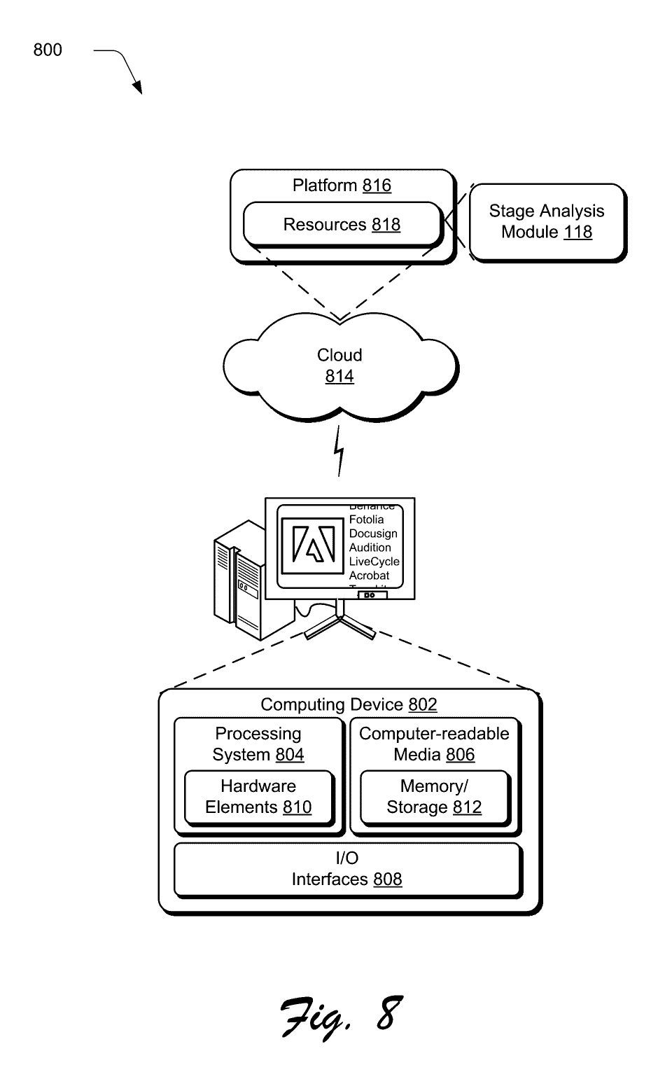

Additionally, although a single device 108 is shown in some instances, the device 108 may be representative of a plurality of different devices. The service provider 102, the analytics service 104, and the marketing service 106 are illustrated as being implemented using multiple servers utilized by a business to perform operations “over the cloud” as further described in relation to FIG. 8, although these services may also be implemented using a single device. Further, functionality representing the service provider 102, analytics service 104, and marketing service 106 may be combined as one or more entities, further divided, and so forth.

The service provider 102 is illustrated as including a service manager module 112 that is representative of functionality to manage and track webpages 114 of one or more websites usable to describe, advertise, and/or purchase goods or services 116. The webpages 114, or instance, may include a home page, be sorted by type of product or service, provide different levels of detail regarding the goods or services 116, and accept purchase information (credit card information, electronic payment information) to purchase the goods and service 116.

In this example, marketing interactions involve interaction of users of the devices 108 with particular ones of the webpages 114. Marketing interactions may refer to selection of particular webpages 114 for viewing, an amount of time spent viewing particular webpages, types of webpages 114 with which the interaction occurs, and so on. Although marketing interactions involving webpages 114 are described in this example, marketing interactions may also include interaction with a variety of other types of marketing campaigns in a digital medium environment, such as interaction with emails, banner ads displayed in a user interface of an application, instant messages, and so forth.

The analytics service 104 is illustrated as including a stage analysis module 118 that is representative of functionality to process usage data 120 that describes the marketing interactions to obtain a stage determination result 122 that describes a particular stage in a buying cycle 124 of a user's interaction with the service provider 102. As previously described, the buying cycle 124 may be represented by a plurality of stages. Examples of these stages include an awareness 126 stage in which a potential customer becomes aware of various offerings of goods or service 116 by the service provider. Once a customer is aware, the customer may shift into an interest 128 stage in which the customer develops an interest regarding particular ones of the goods or services 116.

While browsing through these products of interest, the customer may then enter a desire 130 stage in which the potential customer desires to purchase the particular good or service 116 and performs a focused study thereof to confirm this interest. Once confirmed, the potential customer becomes an actual customer by purchasing the good or service 116 and enters the conversion 132 stage.

At each of the stages of the buying cycle 124, the potential customer has different expectations regarding a desired intensity of marketing interaction with the service provide 102, types of interactions to be performed, and so on. Accordingly, the stage determination result 122 obtained from the usage data 120 may be employed by the marketing manager module 134 and/or service manager module 112 to control subsequent marketing interactions to supply the desired amount and types of marketing interactions and in this way increase a likelihood that potential customers are converted to actual customers. Accordingly, accuracy of this determination is of utmost importance to the marketing service 106, service provider 102, and users of the devices 108. An example of generation of a stage determination result 122 is described in the following implementation example. Again, although interaction with webpages 114 is described, a variety of other marketing interactions usable to estimate a stage in a buying cycle 124 is also contemplated.

Implementation Example

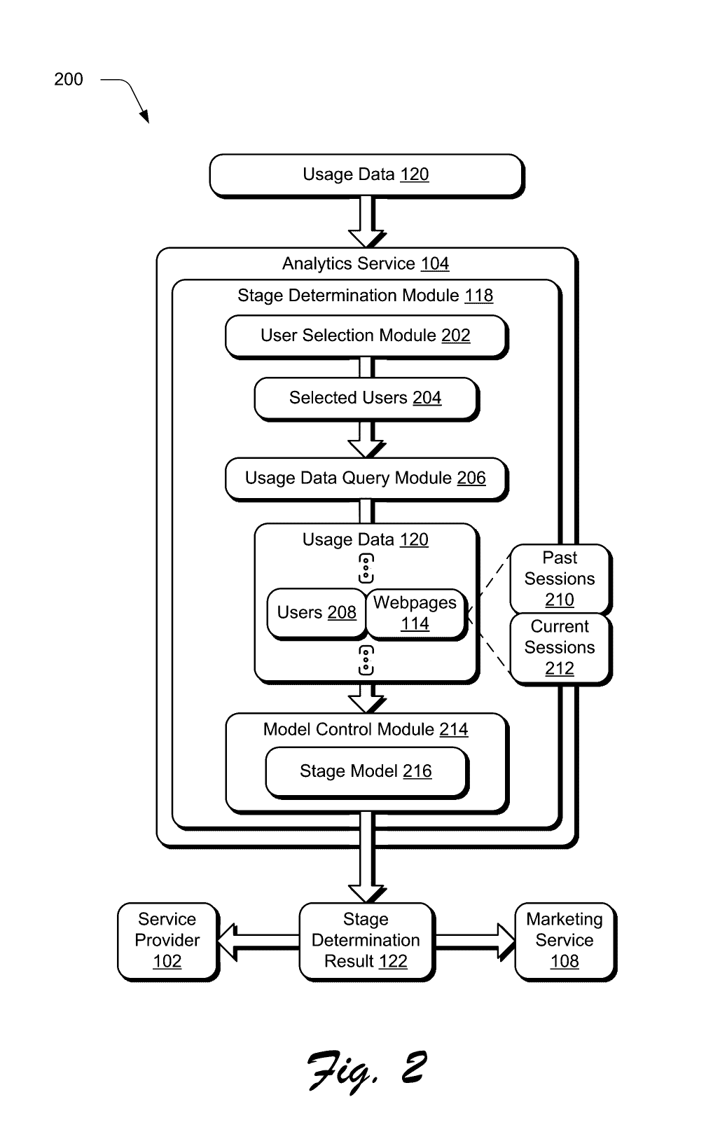

FIG. 2 depicts a system 200 in an example implementation showing a stage determination module 118 of FIG. 1 in greater detail. Generally, a workflow implemented by the stage determination module 118 begins with use of a user selection module 202. The user selection module 202 is representative of functionality to select users 204 from the usage data 120. The user selection module 202, for instance, may output a user interface via which a user may indicate all or a subset of particular users that are described in the usage data 120.

Output of the selected users 204 is then provided to a usage data query module 206 that is representative of functionality to obtain usage data 120 that describes marketing interactions of users 208. In the illustrated example, this involves marketing interactions of users 208 of the devices 108 of FIG. 1 with particular webpages 114 of the service provider 102. Other examples of marketing interactions with other types of marketing campaign implementations are also described, such as with emails or other messages as part of a messaging campaign performed via a digital medium environment 100.

The usage data 120 in the illustrated example includes past sessions 210 and current sessions 212 of the users 208 with the webpages 114. Sessions are semi-permanent interaction information interchanges, also referred to as a dialog, a conversation, or a meeting, between two or more devices. Individual sessions have a start and finish, e.g., “entering” and “leaving” a website which is detectable using a threshold amount of time, logging on and off the website, use of cookies, and so forth. The past sessions 210 in the usage data 120 allow the stage determination module 118 to consider an influence of past marketing interactions (e.g., browsing behavior) on current marketing interactions, which is not possible using conventional techniques as described above.

The usage data 120 is then obtained by a model control module 214 that is representative of functionality to generate and use a stage model 216 to calculate a stage determination result 122, e.g., for one or more users 208 described in the usage data 120. The model control module 214, for instance, may utilize an algorithmic model that identifies various stages of a customer in the buying cycle 124 as described in greater detail below.

The stage determination result 122 is usable in a variety of ways, such as to control subsequent marketing interactions with the users 208 or other users. For example, based on the knowledge gained about the various stages of the selected users, a marketer of a marketing service 108 may strategize marketing decisions accordingly. For instance, sending an informative advertisement (e.g., describing launch of a new good or service 116 and its features) to a potential customer in the desire 130 stage may not be effective as compared to sending the informative advertisement to customers who do not know about the website or its product offerings, i.e., at the awareness 126 stage. Further discussion of operation of the stage determination module is described in the following and shown in corresponding figures.

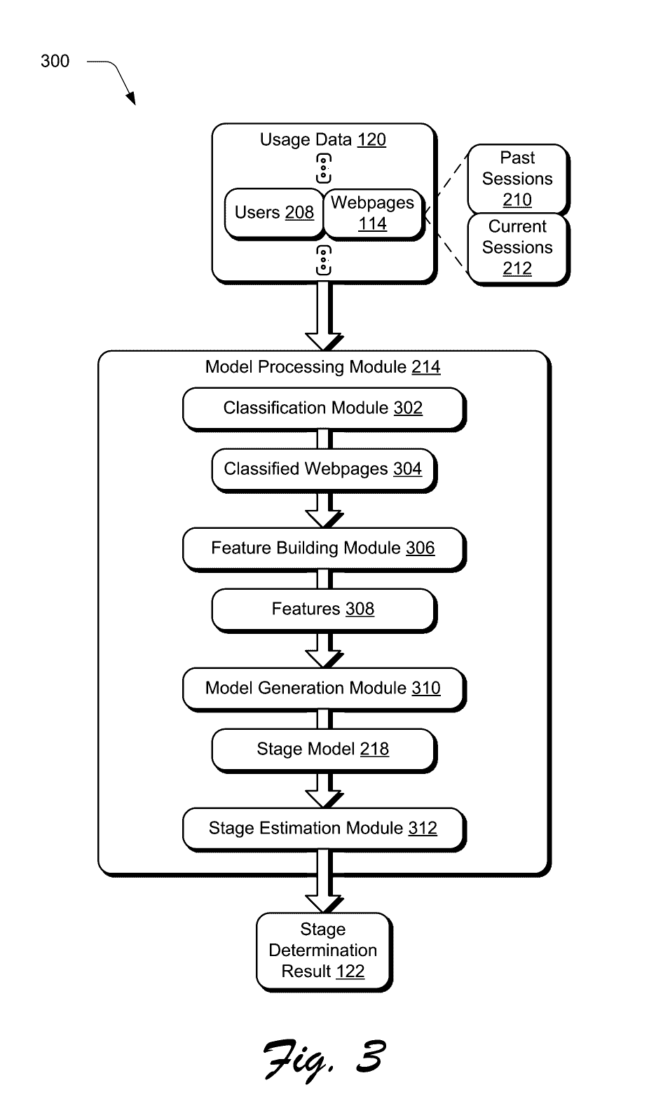

FIG. 3 depicts a system 300 in an example implementation showing operation of the stage control module 214 of the stage determination module 118 of FIG. 2 in greater detail. The model processing module 214 is illustrated as obtaining usage data 210 as described previously. A classification module 302 is then utilized to process the usage data 120 to classify webpages 114 contained therein. In one example, the usage data 120 is describes a clickstream of the users and the marketing interactions exposed to the users.

A clickstream describes the various webpages a user has browsed to on a website. Because a typical website has thousands of unique webpages that could be browsed by a potential customer, consideration of each such click of a user as unique may be inefficient as part of model building. Accordingly, the classification module 203 may be employed to heuristically classify each of the webpages 114 into categories, e.g., based on keywords in each respective URL of the webpages 114.

This technique is also usable for various other marketing interactions that are exposed to potential customers, e.g., a user could be exposed to multiple email campaigns. Hence, the classification module 302 in such an instance may be used to heuristically classify similar marketing interactions instead of considering each as a unique interaction, such as to a product details class (e.g., product detailed communications), category class (e.g., classification of a good or service to a particular product or service category in a webpage), search class (e.g., a webpage used to perform a search for goods or services), and checkout class, e.g., a webpage usable to purchase the good or service.

Usage data 120 having the classified webpages 304 is then obtained by a feature building module 306 that is representative of features 308 of marketing interactions that are to be used as a basis to capture stages of a buying cycle as part of model generation. A variety of different features 308 may be considered. In a first example, marketing touches for each classified type are considered. For instance, after classifying the marketing interactions into different classes, the number of marketing touches of each class are identified for respective users 208.

In another example, the features 308 describe good or service page views. For instance, after the classification of web pages 114 is performed, a number of page views is found for each browsing session of respective users 208 by class, such as for product details, category, search, checkout, and so forth.

In a further example, the features 308 describe an amount of time spent on a class such that for each browsing session of respective users 208, an amount of time (e.g., in seconds) spent by a user 208 on the same set of web pages mentioned above is determined.

In yet another example of features 308, a previous conversion count is used such that for each user, a number of times a user 208 has made purchase in the past is used to capture an affinity of a customer towards the service provider 102. Features 308 may also describe conversion in a session to describe whether a user has made a purchase in the session. Micro-conversion is also contemplated to describe whether the users 208 have added a good or service to a shopping cart of a website.

The features 308 are then obtained by a model generation module 310 to perform parameter estimation to form a stage model 218 that is usable in model stages in the buying cycle 124. In one example, the model generation module 310 employs a non-homogenous Hidden Markov Model (HMM). In a HMM, there are latent states that are not observable and there are transitions between the hidden states over time. From every state, observables are emitted which are usable to identify a corresponding hidden state.

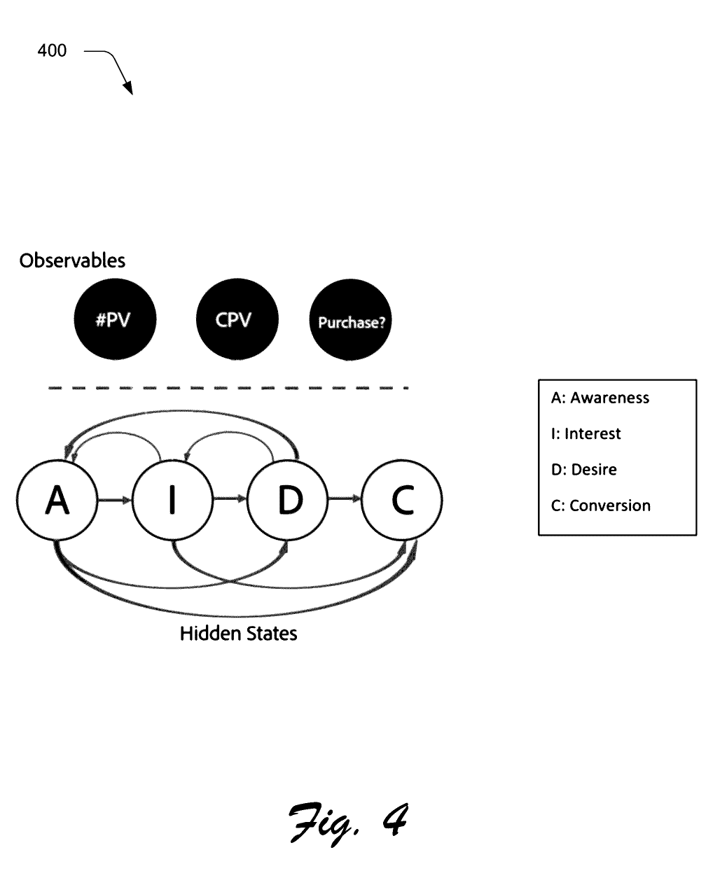

Mapping this to the present examples, stages of a customer's buying cycle 124 cannot be directly observed and thus are interpreted as hidden states. By doing so, the stages can be inferred from the browsing behavior of the customer that are interpreted as observables as part of the HMM. For example, based on a number of pages viewed in a session and the time spent on different types of pages, one can estimate the hidden stage of a customer. An example of this is illustrated by a graph 400 of FIG. 4.

In a conventional HMM, the probability of moving from one hidden state to another is a constant and does not change over time. However, techniques are described herein in which this probability may change. Therefore, if two users 208 are in the same stage (e.g., awareness 126), the probabilities of the users 208 to move to another stage (e.g., interest 128) may be different because of different marketing exposures. Accordingly, the model generation module 310 may employ a non-homogeneous HMM in which the transition probabilities are not constant, but rather are a function of covariates that are referred to as transition covariates. Also, in a standard HMM, the emission probability or the probability to observe a particular observable given the latent state is a constant. However, in the techniques described herein the probability of conversion may be different for two users 208 in the same stage by using observable covariates as further described below.

The model generation module 310 may thus incorporate a variety of features in a non-homogenous HMM model. Model specifications usable to form the stage model 218 by the model generation module 310 include hidden states that model stages in a customer's buying cycle 124, e.g., awareness 126, interest 128, desire 130, and conversion 132. The stage at which a customer is located in the buying cycle 124 can be inferred from the observables emitted. Hence, in observables, features are incorporated that capture the past and current browsing behavior of a user. For each browsing session of a user, for instance, a set of observables may be obtained such as product page view and conversion in a session as explained above.

Cumulative product page views may also be obtained that describes a sum of the product page views counted until a current session. This is included in the observables to take into account the past behavior of a user to estimate the stage as described above. If a user has multiple sessions, then the above set of observables are calculated for each such session and assumed to be the observable sequence of that user.

Transition covariates are also obtained that are usable to describe transitions between the hidden states, e.g., the stages in the buying cycle 124. These include cumulative marketing touches exposed to the user, which is a cumulative sum of the marketing touches exposed to a user over multiple sessions. In another example, a cumulative amount of time spent on product pages is used. Other examples include a conversion count of the user. The purchase count of a user is also incorporated in the transition covariates as it captures the affinity of a user which has to be taken into consideration while determining the state transition of the user. Observable covariates include cumulative marketing touches exposed to the user, since the marketing touches to which a user has been exposed has been found to influence the user's probability of conversion.

In order to form the stage model 218, the model generation module 310 estimates parameters using the above features 308. In one example, transition probability is a function of the transition covariates and is modelled as a multinomial logistic function as follows that is used to described a transition between the hidden states:

$$P ( {S}_{t + 1} = {s}^{′} / {S}_{t} = s , {x}_{it} ; β , μ ) = \frac{exp \{ {β}_{{ss}^{′}}^{T} {x}_{it} + {μ}_{{ss}^{′}} \}}{{\sum }_{{s}^{″}} exp \{ {β}_{{ss}^{″}}^{T} {x}_{it} + {μ}_{{ss}^{″}} \}}$$

where “xᵢₜ” includes the covariates for transition from state “Sₜ” to “Sₜ₊₁” for user “i”.

A probability of conversion from a given state is a function of the observable covariates and is also modelled as a logistic function as follows:

$$P ( {C}_{t} = 1 / {S}_{t} = s , {z}_{it} ; γ , τ ) = \frac{exp \{ {γ}_{s}^{T} {z}_{it} + {τ}_{s} \}}{1 + exp \{ {γ}_{s}^{T} {z}_{it} + {τ}_{s} \}}$$

where “zᵢₜ” includes covariates for conversion at time “t” for user “i” and the “β_{ss′}, μ_{ss′}, γₛ, τₛ” for all “s, s′” are to be estimated.

Each of these parameters are estimated from the observable sequences of customers that are used for training. To learn the parameters, the model generation module 310 trains the stage model 218 using the customer journeys of users who have not been selected by the marketer. Once the parameters are learned, the parameters do not need to be learned again as the same parameters may be used to find the stages of the customers who have not been used for training. In an implementation, a Baum-Welch algorithm or Expectation Maximization Algorithm for Hidden Markov Models is used with a Newton Raphson method in the M-step to estimate these parameters. The Baum-Welch algorithm is used to find those values of the parameters that maximize a likelihood of generating the data, i.e., the observable sequences of customers.

Once the model generation module 310 learns the parameters of the HMM above to form the stage model 218, a stage estimation module 312 may then calculate transition probabilities and emission probabilities for each customer at each points of time using the transition and observable covariates and the equations given above. For each selected customer, the most probable state sequence given an observable sequence may be found by the stage estimation module 312 (e.g., using a Viterbi algorithm) to generate the stage determination result 122.

An effect of marketing interactions on a customer may decay over time, which is not considered in conventional approaches. Hence, in the techniques described herein, instead of considering marketing interactions that occurred over an entire customer journey equally, decay of both interactions as well as browsing activity is considered as a decrease in weight over time to capture the stages of a customer's buying cycle. For example, each of the cumulative features mentioned above is a function of number of sessions of each customer. The number of sessions of each customer is dependent on a number of days that are considered to be the past of a customer.

Hence, the cumulative features may be weighted as a function of number of days that are considered to be the past of a customer, which may be termed the “immediate past” of a customer and defined as “x” in the following. As described above, a journey of the selected users with the service provider 102 is queried by the usage data query module 206, e.g., for the past 100 days. Assuming that the effect of marketing interactions decay over time, for a random sample of users in a dataset, an algorithmic model is built using the techniques described herein to find the stages for various values of “x” and observe accuracy of the model for these values. In an implementation, it has been found that the model performs accurately at “x equals three” and therefore for this implementation each of the browsing sessions that occurred over the past 3 days are collected for the usage data 120 to building the stage model 216. Other examples are also contemplated.

Accordingly, the techniques described above may leverage an affinity of a customer in relation to a service provider. In this way, the techniques may incorporate an awareness that a customer who has already made a purchase from the service provider has an increased likelihood of passing through the stages of the buying cycle more quickly than a user that has not already made a purchase. Additionally, the techniques described above are configurable to assign different weights to different classifications of marketing interactions, e.g., with particular webpages. For example, a customer that views a product details webpage multiple times is likely to have increased interest in regard to a product or service than a customer that views a homepage of the website multiple times. Thus, in a digital medium environment a classification of marketing interactions provides vital understanding of an intent of a user in relation to the interactions and thus insight regarding to which stage in the buying cycle the user has likely progressed.

Further, the techniques described above are configurable to incorporate changes in temporal behavior of a user across multiple browsing sessions, e.g., through use of a non-homogeneous hidden Markov model. For example, a weight may be given to marketing interactions that decays based on an amount of time that has passed since the marketing interactions occurred, e.g., since a user viewed an email, webpage, and so forth. This is performable over multiple sessions with the service provider as described above and thus may also address a user's progression through different stages of a buying cycle over different sessions. The following includes a discussion of example results using the described techniques and systems.

Example Results

The following illustrates example results and advantages of a predictive capability of the proposed techniques over conventional techniques to generate a stage determination result. For proof of concept, the techniques described above are applied on a real-world web analytics dataset. The data set originates from a large e-commerce retailer and describes 13,076,653 browsing sessions of about 5,034,131 unique users over a period of four months. The below table shows the stages of the customer's that came to the website for the first time on March 16 and 17th. Assuming that a marketer is interested in finding the stage of the customer on a present day (e.g., June 1st), the stages of the selected customers are presented on both the days as well as an intermediate day, e.g., on April 17th.

| | | | On June 1st |
|---|---|---|---|
| Stage | On March 16th | On 17th April | (Current day) |
| Awareness | 315 | 232 | 198 |
| Interest | 111 | 163 | 181 |
| Desire | 23 | 38 | 50 |
| Converted | 5 | 21 | 25 |

From the table above, it may be observed that the techniques described herein may be employed to find the stage of a customer in the buying cycle at an arbitrary time point. This is done by considering the user sessions and marketing interactions prior to that date. Also, since the set of customers that were initially selected and analyzed at three different time points are the same (e.g., users who visited the site on March 15th-16th), it may be observed that the number of people in the awareness 126 stage decreases over time and the number of people in a desire 130 stage increases over time. This infers that the selected users are moving through the buying cycle 124 and the marketing activities are influential in doing so.

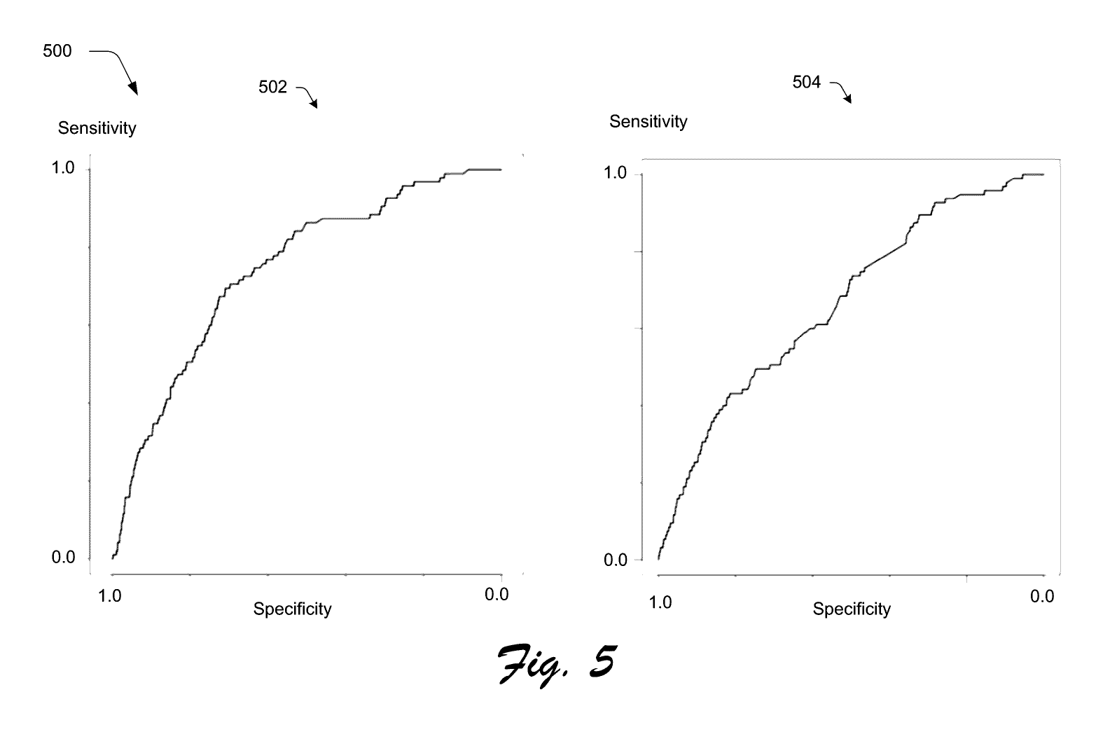

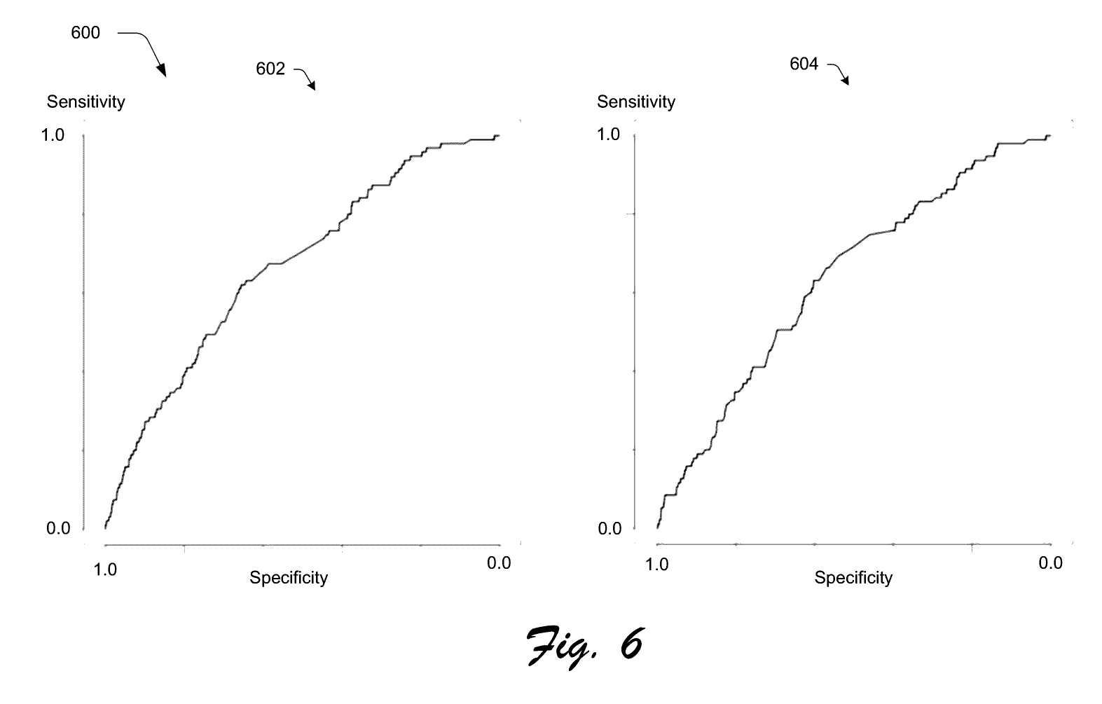

FIGS. 5 and 6 include example implementations 500, 600 having graphs 502, 504, 602, 604 that illustrate goodness of the techniques described herein through evaluation of customer-level predictability. For this purpose, a specific date is chosen for each user. The marketing interactions and sessions before the date are used to predict the probability of conversion of the user in the first session after the chosen date. The rate of conversion (ROC) of the proposed model graph 502 are compared with three other models. 1) logistic regression graph 504 of a model that is extensively used to predict the conversions in the next session; 2) latent stage analysis graph 602 of a model that may be used to capture latent stages, but does not have the properties of a non-homogenous HMM that are mentioned above; and 3) a non-homogenous HMM graph 604 of a model having different features that those used for the proposed model 502. For the same set of holdout sample, the ROC and area under the curve (AUC) are presented in each of the graphs 502, 504, 602, 604 and it may be observed that the proposed model (with the features proposed above) performs better than each of the other models under consideration.

Example Procedures

The following discussion on buying stage determination describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6.

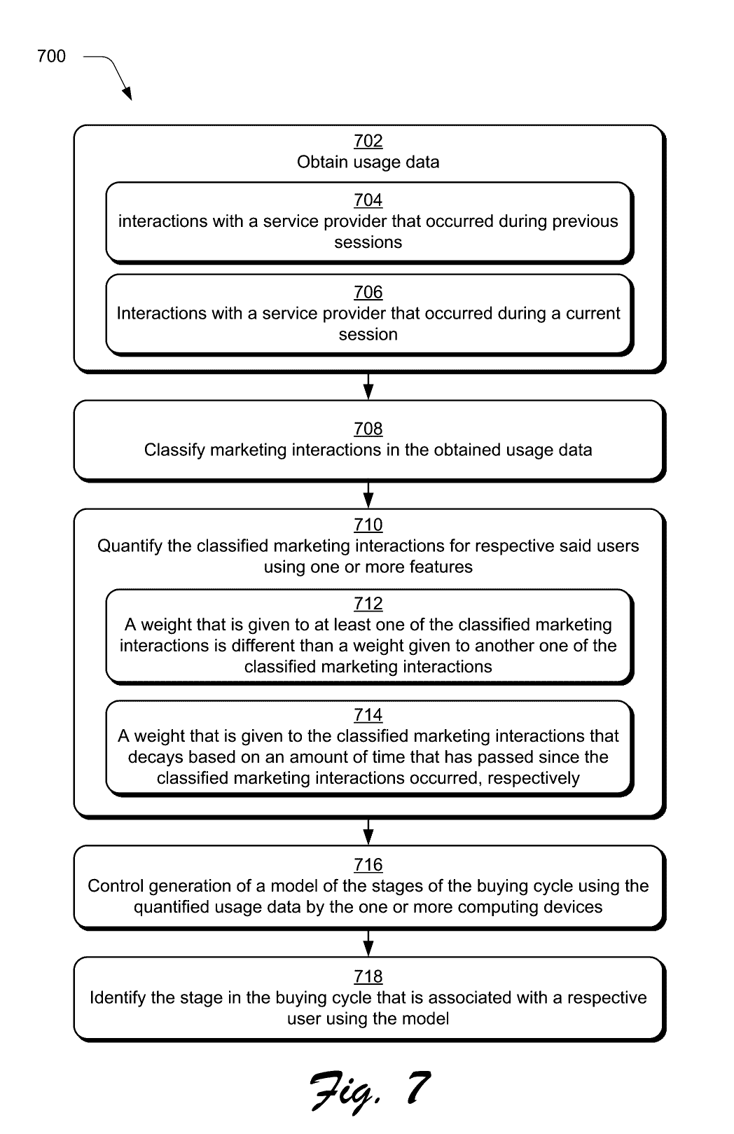

FIG. 7 depicts a procedure 700 in an example implementation involving a digital medium environment to model and control user interaction with a service provider to purchase a good or service through identification of stages in a buying cycle associated with users. Usage data is obtained (block 702) that describes interactions by one or more users with the service provider that occurred during previous sessions (block 704) and interactions with a service provider that occurred during a current session (block 706). A user for instance, may access and leave a website a number of different times in the past, which are then considered past sessions 210. The usage data may also include a current session 212 such that the user 208 is currently accessing the website. Other examples of emails campaigns, phone campaigns, and so on are also contemplated.

Marketing interactions in the obtained usage data are classified by the one or more computing devices (block 708). A product details class, a category class, a search class, a checkout class, and so forth may be used by classification module 302 to differentiate between types of interactions. In this way, differences in the marketing interactions and corresponding indication of a user's 208 interest may become known and thus increase accuracy of the stage determination result 122.

The classified marketing interactions are quantified for respective users using one or more features (block 710). This may include a weight that is given to at least one of the classified marketing interactions that is different than a weight given to another one of the classified marketing interactions (block 712), such as to give greater weight to a product details page over a generalized home page. This may also include a weight that is given to the classified marketing interactions that decays based on an amount of time that has passed since the classified marketing interactions occurred, respectively (block 714). In this way, a likelihood that more recent interactions are more indicative of a current stage is addressed while still leveraging knowledge of previous interactions, thus also increasing accuracy and efficiency in calculation of the stage determination result 122.

Generation of a model of the stages of the buying cycle using the quantified usage data is controlled by the one or more computing devices (block 716). The model, for instance, may employ hidden states that correspond to respective ones of the stages in the buying cycle that are inferred from observables taken from the quantified marketing interactions, such as through use of a hidden Markov model.

The stage in the buying cycles that is associated with a respective user is identified using the model (block 718). A stage estimation module 312, for instance, may process the usage data 120 and/or subsequent usage data that was not used to generate the model to generate the stage determination result 122. This result may be used in a variety of ways, such as to select corresponding ones of a plurality of marketing interactions for exposure to a user automatically and without user interaction.

Example System and Device

FIG. 8 illustrates an example system generally at 800 that includes an example computing device 802 that is representative of one or more computing systems and/or devices that may implement the various techniques described herein. This is illustrated through inclusion of the stage analysis module 118. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to model user interaction with a service provider to purchase a good or service through identification of stages in a buying cycle associated with users, a method implemented by at least one computing device, the method comprising:
obtaining usage data, by the at least one computing device, that at least describes interactions by one or more users with the service provider that occurred during previous sessions;
classifying marketing interactions in the obtained usage data by the at least one computing device;
quantifying the classified marketing interactions for respective said users using one or more features by the at least one computing device; and
controlling generation of a model of the stages of the buying cycle using the quantified marketing interactions by the at least one computing device, the model configured to infer hidden states from the quantified marketing interactions to identify the stage in the buying cycle that is associated with a respective said user.

2. The method as described in claim 1, wherein the quantifying is performed using that classified marketing interactions such that a weight that is given to at least one of the classified marketing interactions is different than a weight given to another one of the classified marketing interaction.

3. The method as described in claim 1, wherein the quantifying is performed using that classified marketing interactions such that a weight that is given to the classified marketing interactions decays based on an amount of time that has passed since the classified marketing interactions occurred, respectively.

4. The method as described in claim 1, wherein the stages of the buying cycle include awareness, interest, desire, and conversion.

5. The method as described in claim 1, wherein the marketing interaction with the service provider involves:
webpages of the service provider; or
communications obtained via a network from the service provider.

6. The method as described in claim 1, wherein the classifying uses a product details class, a category class, a search class, and a checkout class.

7. The method as described in claim 1, wherein the quantifying using the one or more features is based at least in part on a number of the classified marketing interactions for respective classes.

8. The method as described in claim 1, wherein quantifying using the one or more features is based at least in part on an amount of time taken as part of respective ones of the classified marketing interactions.

9. The method as described in claim 1, wherein quantifying using the one or more features is based at least in part on:
a previous conversion count; or
whether a respective said user has selected an item for purchase or has made a purchase from the service provider.

10. The method as described in claim 1, wherein the model is a hidden Markov model.

11. The method as described in claim 1, further comprising forming a stage determination result for the respective said user that identifies the stage in the buying cycle associated with the respective said user, the stage determination result configured to control subsequent marketing interactions by the service provider with the respective said user.

12. In a digital medium environment to identify which of a plurality of stages in a buying cycle is associated with a user to purchase a good or service from a service provider, a system comprising:
a classification module implemented at least partially in hardware to classify marketing interactions occurring between a plurality of users with the service provider;
a feature building module implemented at least partially in hardware to quantify the classified marketing interactions for respective said users such that a weight that is given to at least one of the classified marketing interactions is different than a weight given to another one of the classified marketing interactions;
a model generation module implemented at least partially in hardware to control generation of a model of the stages of the buying cycle using the quantified marketing interactions; and
a stage estimation module implemented at least partially in hardware to identify the stage in the buying cycle that is associated with a respective said user, the identification performed using the model.

13. The system as described in claim 12, wherein the marketing interactions describe:
a current session between the plurality of users and the service provider; and
one or more previous sessions between the plurality of users and the service provider.

14. The system as described in claim 12, wherein the feature building module is configured to quantify the classified marketing interactions such that a weight that is given to the classified marketing interactions decays based on an amount of time that has passed since the classified marketing interactions occurred, respectively.

15. The system as described in claim 12, wherein quantifying is performed at least in part using one or more features that include:
a number of the classified marketing interactions for respective classes;
an amount of time taken as part of respective ones of the classified marketing interactions;
a previous conversion count; or
whether a respective said user has selected an item for purchase or has made a purchase from the service provider.

16. The method as described in claim 12, wherein the model is a hidden Markov model.

17. In a digital medium environment to identify which of a plurality of stages in a buying cycle is associated with a user to purchase a good or service from a service provider, a system comprising:
a classification module implemented at least partially in hardware to classify marketing interactions occurring between a plurality of users with the service provider;
a feature building module implemented at least partially in hardware to quantify the classified marketing interactions for respective said users such that a weight that is given to at least one of the classified marketing interactions is different than a weight given to another one of the classified marketing interaction;
a model generation module implemented at least partially in hardware to control generation of a model of the stages of the buying cycle using the quantified marketing interactions; and
a stage estimation module implemented at least partially in hardware to identify the stage in the buying cycle that is associated with a respective said user, the identification performed using the model.

18. The system as described in claim 17, wherein the marketing interactions describe:
a current session between the plurality of users and the service provider; and
one or more previous sessions between the plurality of users and the service provider.

19. The system as described in claim 17, wherein the feature building module is configured to quantify the classified marketing interactions such that a weight that is given to at least one of the classified marketing interactions is different than a weight given to another one of the classified marketing interaction.

20. The system as described in claim 17, wherein quantifying is based at least in part on one or more features that include:
a number of the classified marketing interactions for respective classes;
an amount of time taken as part of respective ones of the classified marketing interactions;
a previous conversion count; or
whether a respective said user has selected an item for purchase or has made a purchase from the service provider.
